(19) United States
(12) Patent Application Publication
(10) Pub. No.: US 2009/0038724 A1
(43) Pub. Date: Feb. 12, 2009

(54) ANTI-SKID DEVICE LOCATED IN A CIRCUMFERENTIAL GROOVE OF A TIRE

(76) Inventor: Konstantinos Roussos, Thessaloniki (GR)

Correspondence Address: SKOKOS LAW GROUP, LLC, 1100 JORIE BOULEVARD, SUITE 220, OAK BROOK, IL, 60523, US

(21) Appl. No.: 12/278,322

(22) PCT Filed: Jan. 11, 2007
(86) PCT No.: PCT/EP07/50244

§ 371 Date: Aug. 5, 2008

(30) Foreign Application Priority Data
Feb. 7, 2006 (GR) 20060100072
May 3, 2006 (GR) 20060100258

(51) Int. Cl. B60C 27/20

(52) U.S. Cl. 152/219

(57) ABSTRACT

Anti-skid device for tires having a tread with a circumferential groove, whereby the anti-skid device comprises a plurality of contact elements arranged one next to another along line, with each one of the contact elements having an inner face to contact the tire and an outer face to contact the ground and whereby the inner face of the contact elements has a web to be fitted in use within the grooves of the tire of the tire. In a preferred embodiment of the invention, five adjacent contact elements are formed as a single cast module. In this case, the webs of these adjacent contact elements form a single continuous web that joins them together.

### CROSS-REFERENCE TO RELATED APPLICATION

The present application claims priority from Greek application GR 200600100072 filed on Feb. 7, 2006, the content of which is hereby incorporated by reference into this application.

### BRIEF SUMMARY OF THE INVENTION

The invention refers to anti-skid devices for car tires. The device may be applied on any type of vehicle wheels, and in particular on wheels of passenger cars.

### BACKGROUND OF THE INVENTION

The usual means to prevent gliding on the ground surface covered with snow, ice or mud is the use of chains. Known chains are usually applied around the tread of the tires, so that the wheels may rotate on icy roads. However, known chains present problems, because their use reduces the effectiveness of the braking action. Further, the chains decrease the stability of the car and produce vibrations.

The object of the invention is to improve safety of vehicles traveling on slippery ground to resolve the problems that are associated with the use of known anti-skid devices.

### SUMMARY OF THE INVENTION

The anti-skid device for tires according to the invention is defined as an anti-skid device comprising a plurality of contact elements, with each one of the contact elements having an inner face to contact the tire and an outer surface to contact the ground, whereby the inner surface of the contact elements has a web.

The anti-skid device according to the invention improves the adhesion of the wheel to the surface of an icy, wet or slippery road, or more generally the ground, decreases the vibrations and facilitates braking and turning. The installation of the device around the wheel is simple and its application has a universal character, i.e., the anti-skid device may be applied around the wheels of various dimensions and of various types of vehicles. Further it may be used also when the conditions of the surface of the road are normal, i.e., the surface is not slippery. This adds a further advantage, because the driver does not need to install and remove it whenever the conditions of the road surface change, as for example when the car enter or exits a tunnel.

The two ends of the anti-skid device have engagable locking means to engage the two ends of the anti-skid device so that the contact elements form a closed shaped flexible ring structure to be fitted, in use, around the tire. Preferably, the locking means are arranged in the contact elements that are located adjacent to each one of the two ends of the anti-skid device.

In order to improve the fitting of the anti-skid device on the tread of the tire, the anti-skid device has tensioning means to apply tension and to press the anti-skid device on the tread of the tire.

The outer surface of the contact elements may have a protrusion to contact the ground. The protrusion is penetrated by a hole with open ends, which is arranged parallel to the webs. A spring is provided through said holes. The spring has a dual function: it keeps the contact elements together and it provides the tension that presses the anti-skid device around the tire.

Further, spring elements may be optionally provided to improve the adhesion of the tire to the ground. Preferably these elements are arranged in cavities formed on the outer surface of the contact elements. If an anti-skid device contains both a) a spring that keeps the contact elements together, and b) spring elements to improve the adhesion to the ground, the spring elements have a larger diameter, so that they could be arranged around the spring that keeps the contact elements together.

In another embodiment of the invention, at least two adjacent contact elements are formed as a single cast module. In this embodiment, the webs of these adjacent contact elements for a single continuous web that joins them together. Preferably, a module comprises five contact elements.

The contact elements may be manufactured in plastic, for example polyurethane, metal or any other material that provides adequate strength.

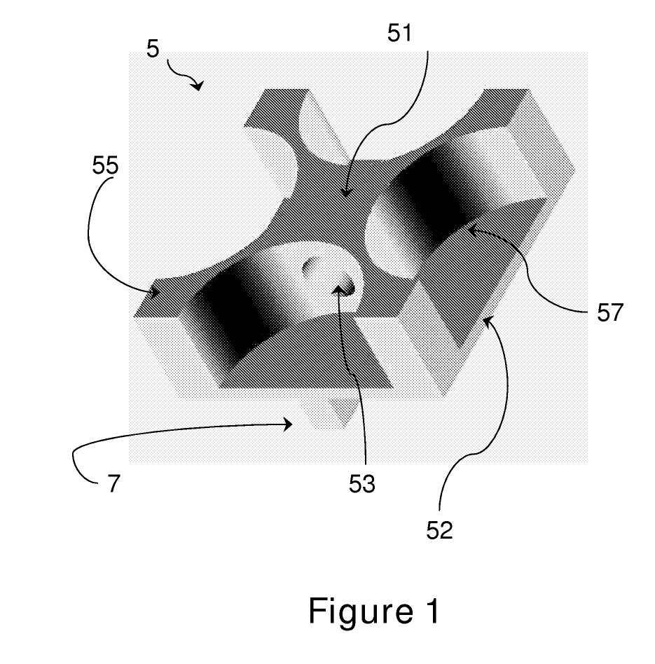

Preferred embodiments of the invention will be described in detail below, with reference to the accompanying FIGS. 1 to 9.

FIG. 1 shows a perspective view of one preferable embodiment of a contact element of the anti-skid device.

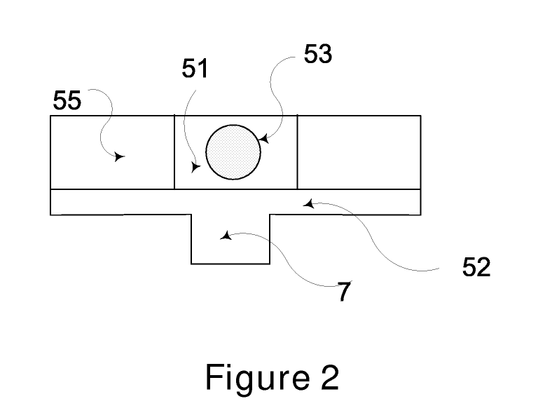

FIG. 2 shows a side view of the contact element.

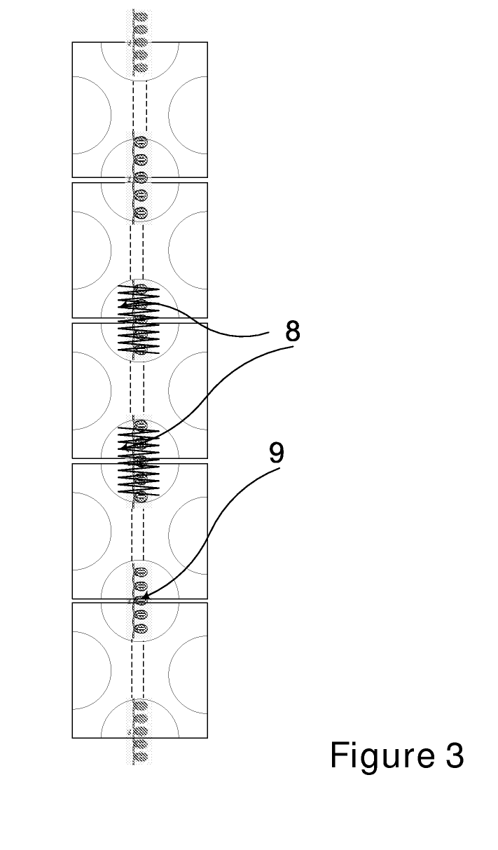

FIG. 3 shows the outer face of five consecutive contact elements with a spring passing through them.

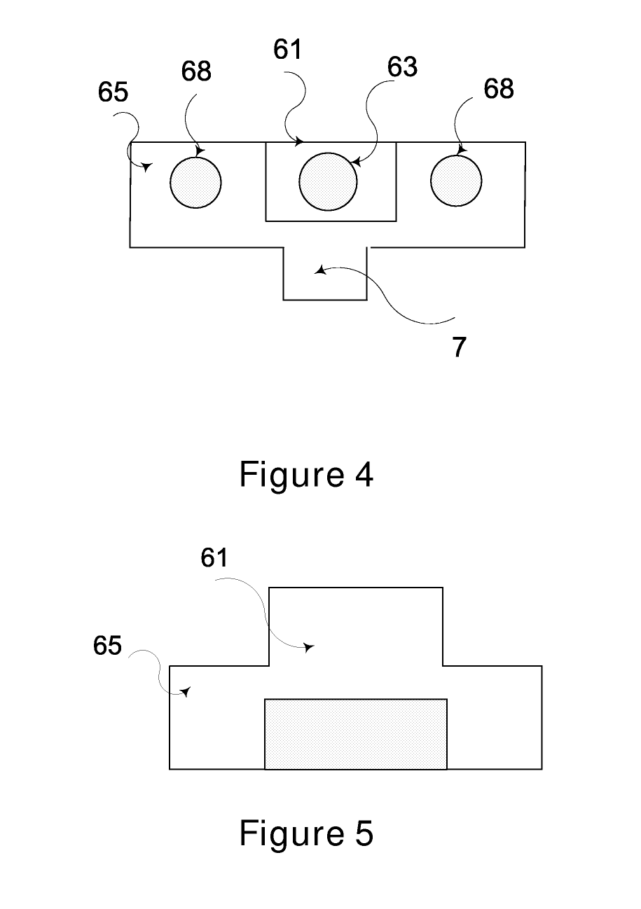

FIG. 4 shows a side of a terminal contact element.

FIG. 5 shows the outer face of a terminal contact element, i.e., the face that comes in contact with the ground when the anti-skid device is applied around the tread of a tire.

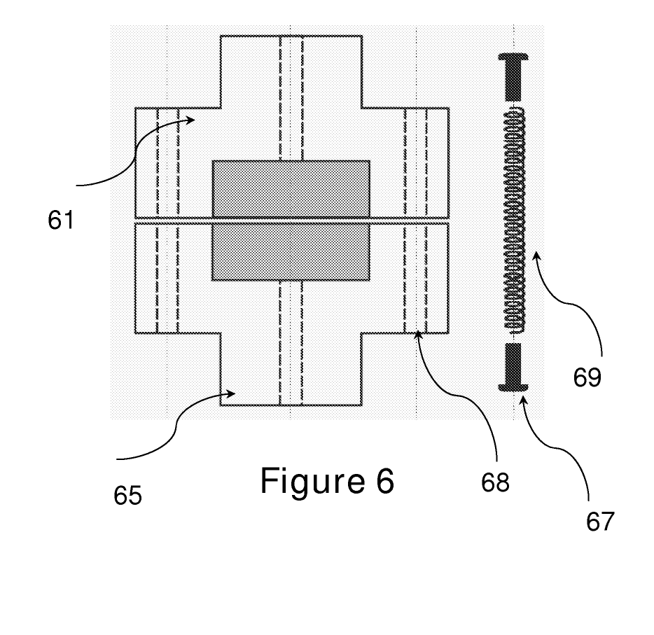

FIG. 6 shows a mode of joining the terminal contact elements.

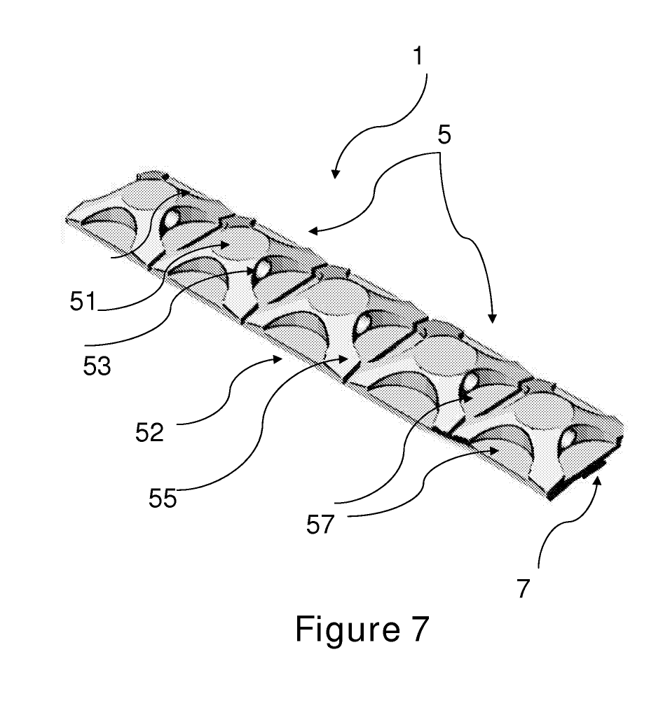

FIG. 7 shows a single cast module with five contact elements.

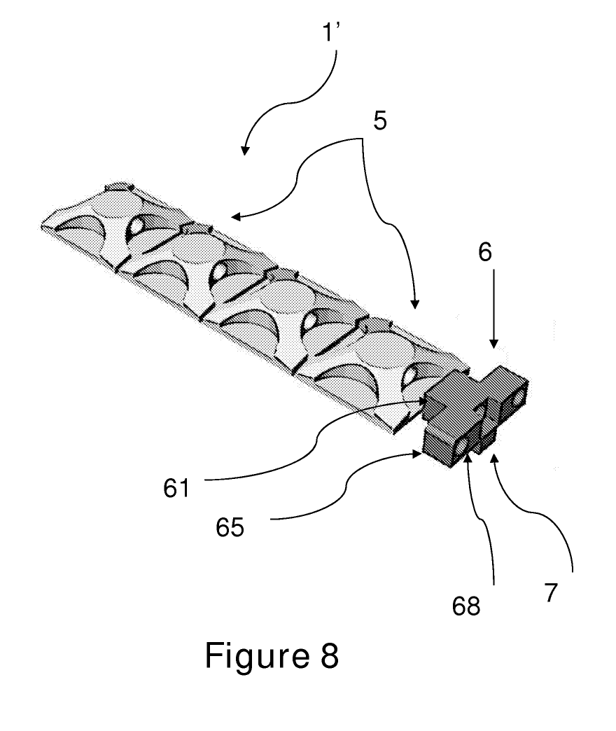

FIG. 8 shows a single cast module with five contact elements, whereby one of the contact elements is a terminal contact element.

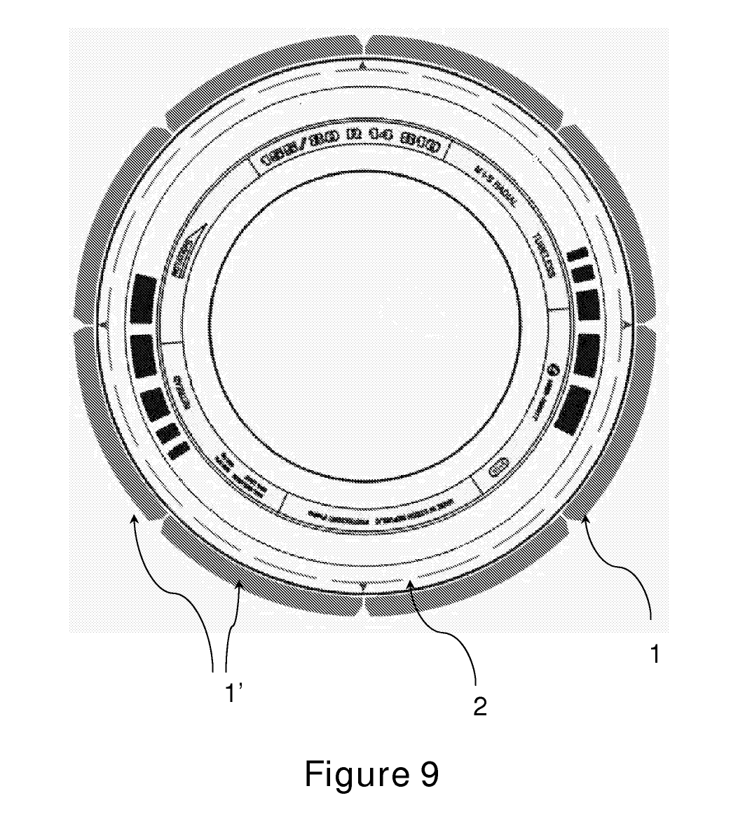

FIG. 9 shows an anti-skid device according to the invention applied around the tread of a tire.

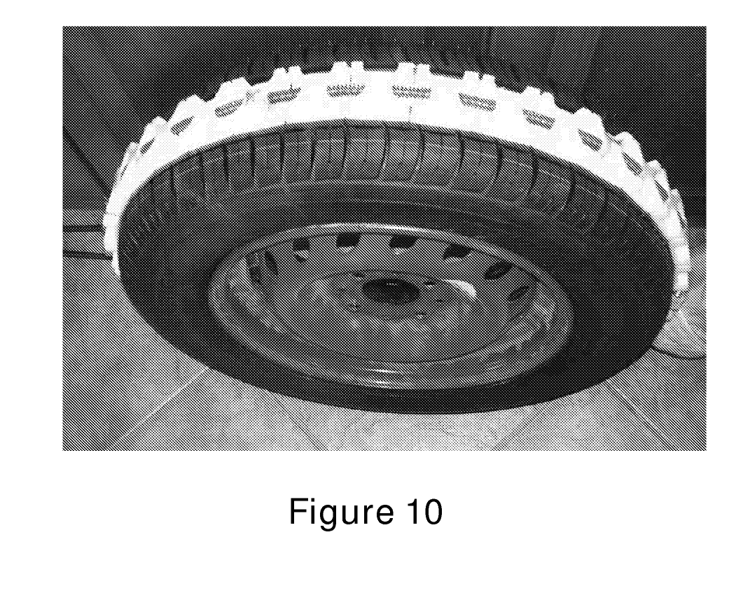

FIG. 10 shows a photograph of a tire with an anti-skid device according to the invention.

### DETAILED DESCRIPTION OF THE INVENTION

An embodiment of an anti-skid device according to the invention comprises contact elements 5, such as the contact element 5 that is shown in FIG. 1. The element has a base 52 having a shape of a parallelepiped, with an inner face that contact the tread of the tire and an opposite outer face that contacts the ground. The edge of the rectangular face of the embodiment of FIG. 1 is approximately 45 mm and the thickness of the parallelepiped is approximately 3 to 4 mm. The inner face of the contact element 5, i.e., the face that comes in contact with the tread of the wheel, has a web 7, which is to be fitted within the circumferential groove of the tread of the tire. The outer surface of the contact element 5, i.e., the face that contacts the ground, has a protrusion 51, located in its center. The protrusion 51 has a longitudinal cylindrical hole 53, which is arranged parallel to the web 7. Between the protrusion 51 and the four peaks of the rectangular outer face, there are four ribs 55 that stiffen the element 5. According to the embodiment shown in FIG. 7, the height of the ribs 55 decreases towards the peaks of the rectangular face. Four cavities 57 are formed between ribs 55. Two, out of the four cavities 57 communicate via the open ended cylindrical hole 53. The height of the embodiment of the contact element of FIG. 1, i.e., the distance from the free edge of the web to the top of the protrusion 51 is approximately 18 mm.

The anti-skid device consists of a plurality of contact elements 5, arranged in a row, one next to another along a line, with the webs 7 disposed along the same line. The elements 5 are connected with a spring 9. The two ends of the anti-skid device have engagable locking means to lock its ends, so that the contact elements form a closed-shaped flexible structure to be fitted, in use, around the tire. Preferably, the locking means are arranged in the contact elements that are located adjacent to each one of the two ends, of the anti-skid device, as described below.

The spring 9 is passing through the cylindrical holes 53, which penetrate the protrusions 51 of the contact elements 5. FIG. 3 shows five consecutive contact elements connected by the spring 9. Each one of the two ends of the spring 9 is anchored to its respective terminal contact element 6. The terminal contact elements 6 are presented in FIGS. 4, 5, 6, and 8. The terminal contact element 6 has an inner face that contacts the tread of the tire and an opposite outer face that contacts the ground. The inner face of the terminal contact 6, i.e., the face that comes in contact with the tread of the tire has a web 7, which is fitted, in use within the grove of the tread of the tire. The outer face of the terminal contact 6, i.e., the face that comes in contact with the ground, has a protrusion 61 on its center, and two ears 65 disposed one to the left and the other to the right of the protrusion 61. A cylindrical hole 63 penetrates the protrusion 61, which when the anti-skid devise is in place, is disposed approximately along the same line with the respective cylindrical hole 53 of the adjacent contact element. Each end of the spring 9 is anchored within a hole 63 of a terminal element. The end of the spring may be maintained in its anchoring position via anchoring means. A hole 68 is provided in each of the ears 65. The terminal contact 6 is cast and made of polyurethane, similarly to the contact element 5.

The anti-skid device is assembled as presented below: The first time that the user wishes to put the anti-skid device around a wheel, he or she will join the two terminal contact elements 6 using the locking means that are provided at the ends of the anti-skid device. In the preferred embodiment, the locking means are provided on the terminal contact elements 6. These locking means comprise bolts and nuts that pass through the holes 68 formed in the ears 65 of the terminal contact elements 6. When the terminal contact elements are locked together, the contact elements 5 and 6 form a flexible ring structure with a closed cross section, to be fitted around the tread of the tire. The flexibility of the structure allows it to be fitted around the wheel and to follow the deformations of the wheel as it moves on any ground or road. The anti-skid device has an inner surface and an outer surface. The inner surface of the anti-skid device consists of the inner surfaces of the contact elements 5 and the terminal contact elements 6 and the outer surface of the anti-skid device consists of the outer surfaces of the contact elements 5 and the terminal contact elements 6. The webs 7 are disposed along the circumference of the inner surface and the protrusions 51 and the ribs 55 in the outer surface of the anti-skid device. The webs 7 will be inserted within the circumferential groove of the tread of the wheel and will guide the anti-skid device in its position around the wheel of the vehicle. When the device is placed around the wheel, the protrusions 51 and the ribs 55 will contact the surface of the road or the ground. The anti-skid device may be applied to wheels having different dimensions by selecting the appropriate number of contact elements. This could be easily done by adding or removing contact elements 5 from it. The anti-skid device is then ready to be applied around the wheel. The anti-skid device is easily fitted to the wheel of the car by simply placing the device over the upper part of the tire, namely the part of the tire that is not in contact with the ground, and fitting the webs 7 within the circumferential groove or grooves of the tread. The hanging part of the devise is then left to hang between the tread of the tire and the ground. By driving the car slightly, the wheel turns and the part of the device that is not fitted around the tread, i.e., the hanging part, is also fitted around it. Thus the anti-skid device is installed along the whole periphery of the tread. The tension of the spring 9 increases the pressure between the tire and the anti-skid device and further secures the device in position around the tread of the wheel.

FIG. 6 presents an example of tensioning means, other than the spring 9, which develop a tension along the anti-skid device and presses the device towards the tread of the wheel. These means function between the two terminal contact elements 6 or between any adjacent contact elements of the anti-skid device. In particular, FIG. 6 shows that the two terminal contact elements are kept together by two springs 69, which springs are passing the holes 68 of the contact elements 6. The ends of these springs are anchored to anchoring means 67, which are attached to the terminal contact elements 6. When the terminal contact elements are joined and the anti-skid device assembled, the springs 69 are in tension within the holes 68. In the example of the anti-skid device of FIG. 6, the spring 9 may be substituted by one or more metal sheets or by any other means that may keep the contact elements together, such as a cable. In a further embodiment, each pair of adjacent contact elements are kept together by a thin metal sheet anchored in these contact elements.

A further embodiment of an anti-skid device in accordance with the invention, which offers further advantages, is presented in FIGS. 7 and 8. In this embodiment, five contact elements are formed as a single cast element, i.e., module 1. Module 1 is made of polyurethane and is cast. The webs 7 are formed by one single continuous web that has a double function: it is fitted within the groove of the tread of the tire and guides the anti-skid device in position on one hand, and keeps the five contact elements together on the other. This mode of joining the contact elements together allows the relative rotation of any contact element with respect to its adjacent contact elements, so that the antiskid may be deformed as the wheel rotates on the surface of the road or the ground. The antiskid device made of the modules shown in FIGS. 7 and 8 may be fitted around the wheel relatively simply and it provides a flexibility that allows it to follow the deformations of the tread of the wheel. FIG. 8 presents a module 1′, which consists of four contact elements 5 and a terminal contact element 6. Module 1′ is cast, it is made of polyurethane and the webs 7 of the four contact elements 5 and the terminal contact element 6 is a single continuous web. FIG. 9 present an anti-skid device which consist of modules 1 and 1′ fitted around a tire of a vehicle have a groove 2. Similarly to the case of the anti-skid device that consists of individual contact elements 5 and 6, the modules 1 and 1′ of the anti-skid device of FIG. 9 are kept together by a spring 9. A picture of a tire with an anti-skid device according to the invention is shown in FIG. 10.

An optional feature of the anti-skid device are the spring elements 8, which are located in the cavities 57 around spring 9, as shown in FIG. 3. FIG. 3 shows two spring elements 8 located in two cavities 57. Spring elements 8 may be optionally provided in all cavities and may be placed around spring 9. I the spring elements 8 are placed around spring 9, spring elements 8 have a larger diameter and a short length than the diameter and length of spring 9. The use of spring elements 8 improves the adhesion of the wheels to the surface of the road.

The embodiments that have been presented have dimensions that allow the invention to be used in various types of tires. The contact elements may be manufactured in plastic, for example polyurethane, metal or any other material that provides adequate strength.

1. Anti-skid device for tires comprising a plurality of contact elements (5, 6), with each one of the contact elements having an inner face to contact the tire and an outer face to contact the ground, whereby the inner face of the contact-elements has a web (7).

2. Anti-skid device according to claim 1, whereby the contact-elements (5, 6) are made of polyurethane.

3. Anti-skid device according to claim 1, whereby the anti-skid device has two ends and a contact element (6) adjacent to each one of the two ends, and whereby the two contact elements that are arranged adjacent to each one of the two ends have complementary locking means to engage these two elements to each other, so that the plurality of the contact elements (5, 6) form a flexible ring structure to be fitted in use around the tire.

4. Anti-skid device according to claim 1, further comprising tensioning means (9) to apply tension to the anti-skid device.

5. Anti-skid device according to claim 1, whereby the outer surface of the contact-elements have a protrusion (51, 61).

6. Anti-skid device according to claim 1, whereby the outer surface of the contact-elements (5, 6) have a protrusion (51, 61), the said protrusions have holes (53, 63) with open ends arranged parallel to the webs (7), and whereby a spring means (9) is provided through the said holes (53, 63).

7. Anti-skid device according to claim 1, further comprising spring elements (8) to come in contact the ground.

8. Anti-skid device according to claim 1, further comprising at least one spring element (8) between two adjacent contact-elements to come in contact the ground.

9. Anti-skid device according to claim 1, whereby at least two adjacent two contact-elements (5, 6) is a single cast element, and whereby the webs (7) of the said at least two adjacent contact-elements (5, 6) form a single continuous web that join the said at least two contact-elements (5, 6) together.

10. Anti-skid device according to claim 1, whereby five contact-elements (5, 6) is a single cast element, and whereby the webs (7) of the said five contact-elements (5, 6) form a single continuous web that join the said contact-elements (5, 6) together.
